(19) United States
(12) Patent Application Publication
(10) Pub. No.: US 2011/0225076 A1
(43) Pub. Date: Sep. 15, 2011

(54) METHOD AND SYSTEM FOR DETECTING FRAUDULENT INTERNET MERCHANTS

(75) Inventors: Xiaohang Wang, Jersey City, NJ (US); Andrew Robert Mitchell, Sunnyvale, CA (US); Lawrence Poi Heng Ip, Emerald Hills, CA (US); Shubin Zhao, Chatham, NJ (US); Andrew John Nowka, Mountain View, CA (US)

(73) Assignee: Google Inc., Mountain View, CA (US)

(21) Appl. No.: 12/720,082

(22) Filed: Mar. 9, 2010

(51) Int. Cl. G06Q 40/00

(52) U.S. Cl. 705/35

(57) ABSTRACT

Systems and methods for detecting fraudulent merchants using the content of orders completed by the merchants. A fraud detection engine of a fraud detection system generates a fraud detection model using feature data extracted from order content data for known fraudulent and known non-fraudulent merchants. The fraud detection engine executes the model using feature data extracted from order content data for a target merchant to determine a fraud risk associated with the target merchant. If the fraud risk of the merchant is indicative of a fraudulent merchant, the fraud detection system can issue a request to a fraud analyst to review the target merchant further. The results of the fraud analyst's review can be used to update the fraud detection model.

### TECHNICAL FIELD

The invention relates generally to fraud detection in Internet commerce. In particular, the invention relates to detecting fraud associated with Internet merchants.

### BACKGROUND

Online payment processors provide a convenient way for Internet merchants and consumers to complete payments for transactions via the Internet. Generally, a consumer can sign up for an account with the online payment processor and store payment information for one or more payment options in the account. The merchant can similarly sign up for an account to receive payment for products sold by the merchant via the online payment processor. Thereafter, the consumer can purchase a product from the merchant without providing information associated with a payment account, such as a credit card, to the merchant. Instead, the consumer can use one of the payment options in the account to pay the online payment processor and the online payment processor can, in turn, pay the merchant for a transaction. Typically, the online payment processor charges the merchant a fee for this service. Additionally, many online payment processors provide a guarantee to the consumer against any fraudulent activity associated with the merchants that accept payment via the online payment processor.

However, online payment processors are not immune from merchant fraudulent activity. One common form of merchant fraud associated with online payment processors is merchants receiving orders and payment for the orders without actually delivering the content of the orders to the customers or delivering inferior products. Conventionally, online payment processors rely on feedback from the customers to detect this fraudulent activity. If it has been determined that a merchant has been fraudulent, the online payment processor can discontinue the account. However, by the time that the online payment processor receives the feedback from the customers, the fraudulent merchant may have defrauded many other customers. For example, a fraudulent merchant may take orders and receive payments for tickets to a concert that cannot be delivered until a certain date. During the timeframe of receiving the payment and the customer realizing that they will not receive the tickets, the fraudulent merchant may have defrauded many other customers.

Another form of merchant fraud associated with online payment processors involves fraudulent merchants signing up fake customers with the online payment processor using stolen credit card numbers. The fraudulent merchant then uses these fake customer accounts to purchase products from the Internet website of the fraudulent merchant without delivering any product. Instead, the fraudulent merchant simply receives the payment from the stolen credit cards via the online payment processor. The online payment processor could give the fraudulent merchant a significant amount of money before being alerted to the fact that the credit card numbers were stolen. Typically, the credit card owner would have to discover that the card was stolen and report it to a credit card company. The credit card company would then notify the online payment processor, the process of which could take weeks or longer.

Accordingly, a need in the art exists for a method and system for detecting fraudulent merchants in a quick and precise manner.

### SUMMARY

One aspect of the present invention provides a computer program product for detecting a fraudulent merchant. This computer program product can include a computer-readable medium including computer-executable program code for extracting feature data from transactions completed by a merchant, the feature data including information associated with one or more products purchased in a transaction; computer-executable program code for executing a fraud detection model using at least the extracted feature data to determine a risk score for the merchant based on the extracted feature data and a correlation of at least a portion of the extracted feature data with feature data associated with known fraudulent merchants; and computer-executable program code for identifying the merchant for a further action based on the risk score for the merchant.

Another aspect of the present invention provides a computer program product for detecting a fraudulent merchant. This computer program product can include a computer-readable medium including computer-executable program code for extracting feature data from transactions completed by a merchant, the feature data including information associated with one or more products purchased in a transaction; computer-executable program code for executing a fraud detection model using at least the extracted feature data to determine a risk score for the merchant based on the extracted feature data and a correlation of at least a portion of the extracted feature data with feature data associated with known fraudulent merchants; computer-executable program code for determining whether the risk score for the merchant includes a risk score indicative of a fraudulent merchant; and computer-executable program code for classifying the merchant as fraudulent based on a determination that the risk score for the merchant includes a risk score indicative of a fraudulent merchant.

Another aspect of the present invention provides a system for detecting fraudulent merchants. This system can include an online payment processor for receiving transaction data associated with transactions completed by merchants, the transaction data including information associated with one or more products purchased in a transaction; a feature extractor in communication with the online payment processor for extracting feature data from the transaction data; and a fraud detection engine. The fraud detection engine can receive the extracted feature data from the feature extractor for each merchant; execute the fraud detection model using at least the extracted feature data to determine a risk score for each merchant based on the extracted feature data for that merchant and a correlation of at least a portion of the extracted feature data for that merchant with order content data associated with known fraudulent merchants; and identify each merchant for a further action based on the risk score for the merchant.

These and other aspects, features, and embodiments of the invention will become apparent to a person of ordinary skill in the art upon consideration of the following detailed description of illustrated embodiments exemplifying the best mode for carrying out the invention as presently perceived.

### BRIEF DESCRIPTION OF THE DRAWINGS

For a more complete understanding of the exemplary embodiments of the present invention and the advantages thereof, reference is now made to the following description in conjunction with the accompanying drawings in which:

FIG. 1 is a block diagram depicting a system for detecting fraudulent merchants in accordance with certain exemplary embodiments.

FIG. 2 is a flow chart depicting a method for detecting fraudulent merchants in accordance with certain exemplary embodiments.

FIG. 3 is a flow chart depicting a method for generating a fraud detection model in accordance with certain exemplary embodiments.

### DETAILED DESCRIPTION OF EXEMPLARY EMBODIMENTS

Exemplary embodiments of the invention are provided. These embodiments include systems and methods for detecting fraudulent merchants using the content of orders completed by the merchants. A fraud detection engine of a fraud detection system generates a fraud detection model using feature data extracted from order content data for known fraudulent and known non-fraudulent merchants. The fraud detection engine executes the model using feature data extracted from order content data for a target merchant to determine a fraud risk associated with the target merchant. If the fraud risk of the merchant is indicative of a fraudulent merchant, the fraud detection system can issue a request to a fraud analyst to review the target merchant further. The results of the fraud analyst's review can be used to update the fraud detection model.

Embodiments of the invention can comprise a computer program that embodies the functions descried herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement an embodiment of the disclosed invention based on the flow charts and associated description in the application text. Therefore, disclosure of a particular set of program code instructions is not considered necessary for an adequate understanding of how to make and use the invention. The inventive functionality of the claimed invention will be explained in more detail in the following description, read in conjunction with the figures illustrating the program flow.

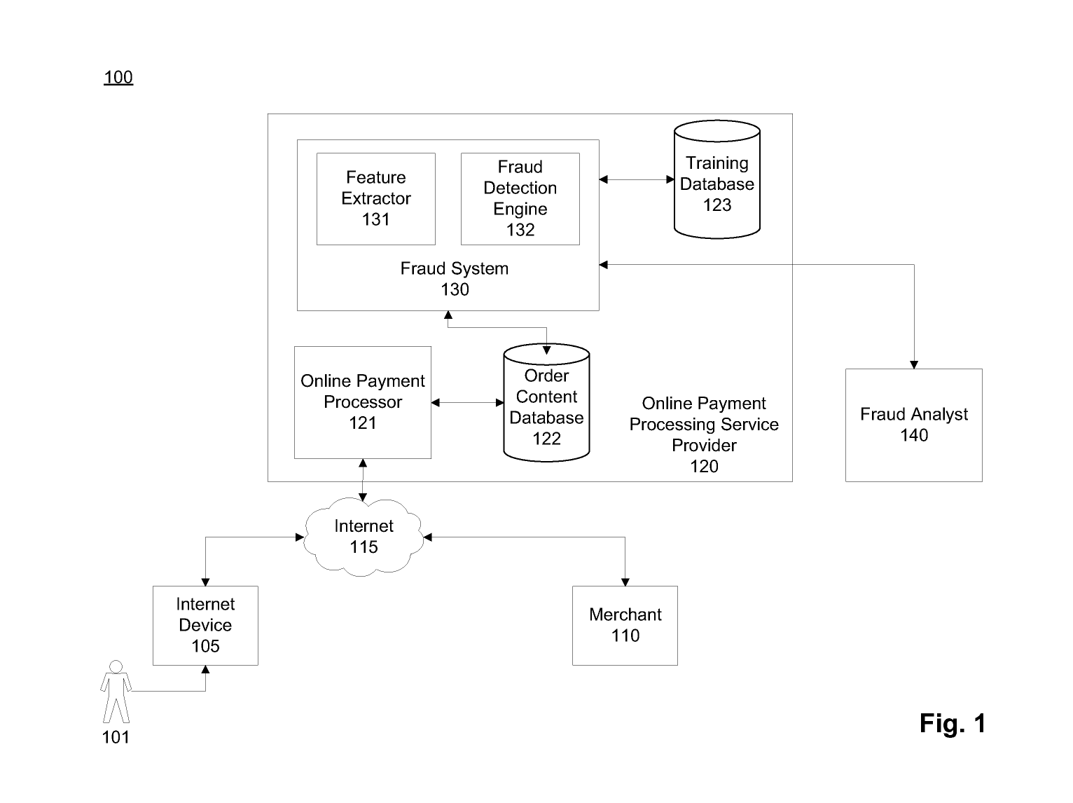

A method and system for detecting fraudulent merchants will now be described with reference to FIGS. 1-3, which depict representative or illustrative embodiments of the invention. FIG. 1 is a block diagram depicting a system 100 for detecting fraudulent merchants 110 in accordance with certain exemplary embodiments. The exemplary system 100 includes an online payment processing service provider 120. The online payment processing service provider 120 includes an online payment processor 121. The online payment processor 121 mediates payments for purchases made by consumers, such as consumer 101, from Internet merchants, such as merchant 110. The consumer 101 can sign up for an account with the online payment processor 120 and provide one or more payment options, such as a credit card, debit card, or checking account, for use with Internet purchases. The merchant 110 can also sign up with the online payment processor 121 to receive payments from consumers 101 via the online payment processor 121. Subsequently, the consumer 101 can browse an Internet website provided by the merchant 110 via an Internet device 105 in communication with the Internet 115. The Internet device 105 can include a computer, smartphone, personal digital assistant (“PDA”) or any other device capable of communicating via the Internet 115. After finding a product to purchase, the consumer 101 can purchase the product using the account with the online purchase processor 121 without providing a credit card number or other payment account information to the merchant 110. As used throughout the specification, the term “products” should be interpreted to include tangible and intangible products, as well as services.

The online payment processor 121 can receive from the merchant 110 information associated with each order that the merchant 110 completes via the online payment processor 121. This information can include merchant order content data having information associated with the contents of each order completed by the merchant 110. The information can also include the price paid for each product in the orders. The online payment processor 121 stores this merchant order content data in a order content database 122 stored on or coupled to the online purchase processor 121.

The online payment processing service provider 120 also includes a fraud system 130 for detecting fraudulent merchants 110. The fraud system 130 includes a feature extractor 131 and a fraud detection engine 132. The fraud detection engine 132 develops and executes one or more merchant fraud detection models to detect fraudulent merchants 110. The fraud detection models are developed to detect fraudulent merchants 110 based at least on the merchant content data associated with the merchant 110. Empirically, the content of the merchant's 110 orders can provide insight that can be used by the merchant fraud detection models to differentiate fraudulent merchants 110 from non-fraudulent merchants 110. For example, repeat fraudulent merchants 110 tend to sell the same products when they open accounts with online payment processors 121. In another example, statistics show that certain products, product categories, and/or certain accessories tend to have a higher correlation with fraudulent orders. Also, certain terms in the product description or title are more likely to be associated with fraudulent orders. Associating product and price can also help detect fraudulent activity as a common fraud mechanism is to sell products at an undervalued price. Each of these empirical data and patterns make order content an excellent source of risk signals for detecting fraudulent merchants 110.

The fraud system 130 includes at least three phases, a training phase, a prediction phase, and a review phase. In the training phase, a set of training data is collected and stored in a training database 123. This training data can include data associated with multiple Internet merchants 110 and order content data associated with each of the merchants 110. In certain exemplary embodiments, the merchants 110 included in the training data are merchants 110 that have accounts with the online payment processor 121. In certain embodiments, merchant and order content data can be obtained from external sources for use in the training phase. After the training data is collected, a fraud analyst 140 can review the training data and label each merchant 110 as fraudulent or non-fraudulent. Alternatively, if the training data was received from an external source, the merchants 110 may already be labeled.

The feature extractor 131 can extract relevant feature data from the labeled merchant and order content data. The feature data can include bag-of-word tokens (i.e., searching without regarding to the order of the words) from title and product descriptions from the merchants' 110 orders, bigrams (or other N-grams) over the bag-of-word tokens, and conjunctions of terms and binned prices. Other examples can include the timing, frequency, and/or patterns of orders processed by a merchant 110. Additionally, certain third-party data relating to the order and merchant 110 can be considered, such as reviews of the merchant 110 on various third-party sites and the shipping company used by the merchant 110. Various features of the merchant's 110 website also can be considered in identifying a correlation with fraudulent orders, such as the text, coding style, or other website features or characteristics that would be recognized by one of ordinary skill in the art having the benefit of the present disclosure. The fraud detection engine 132 can then learn the correlations between the labels and the extracted features and develop one or more merchant fraud detection models based on these correlations. The merchant fraud detection models can be developed based on a probability based scoring algorithm, Naïve Bayes classifiers, Perceptron classifiers, Winnow classifiers, support vector machine (“SVM”) classifiers, or any other statistical modeling that would be recognized by one of ordinary skill in the art having the benefit of the present disclosure.

In the prediction phase, the unlabeled order content data for a merchant 110 is used to detect whether the merchant 110 is fraudulent or non-fraudulent. The feature extractor 131 extracts relevant feature data from the merchant's 110 order content data. This feature data can include terms used in the description or title of products ordered from the merchant 110, the price of the products ordered, and any other information associated with the contents of the orders. The fraud detection engine 132 then executes the fraud detection models using the extracted feature data. In certain exemplary embodiments, the output of the fraud detection models is a classification of a given merchant 110 as fraudulent or non-fraudulent. Alternatively or additionally, the fraud detection models can determine a merchant risk score corresponding to the likelihood that the merchant 110 is fraudulent.

In certain exemplary embodiments, the merchant fraud detection models output a merchant risk score for the merchant 110 based on the order content data. For example, the output of the merchant fraud detection model may be a score normalized between zero and one for the merchant 110, where a score of zero corresponds to a confident prediction that the merchant 110 is non-fraudulent and a score of one corresponds to a confident prediction that the merchant 110 is fraudulent. The merchant 110 may then be identified for further action based on the risk score, such as identifying the merchant 110 as fraudulent or non-fraudulent, or issuing a request for the merchant 110 reviewed further, as discussed below.

In certain exemplary embodiments, the merchant risk score may include a sum of fraud probabilities for each of the features from the merchant's 110 order content data. For example, each term in a product description included in the feature data may be given a fraud probability based on the term's correlation with fraudulent merchants. The fraud probability for each term can then be added together—or otherwise combined—to get a total merchant fraud probability. The total merchant fraud probability can then be normalized to a range of zero and one as described above.

In the review phase, the fraud detection engine 132 can issue a request for certain merchants 110 to be reviewed further by the fraud analyst 140. The fraud detection engine 132 may issue requests for further review for merchants 110 classified as fraudulent by the fraud detection model(s). Also, the fraud detection engine 132 may prioritize the reviews based on the merchant risk score for the merchants 110. The merchants 110 may also be prioritized based on the possible financial impact of a merchant 110 or based on an amount of time since the merchant 110 was previously reviewed. After reviewing the merchants 110, the fraud analyst 140 labels each merchant 110 as fraudulent or non-fraudulent based on the review. The fraud detection engine 132 can use the order content data for the merchants 110 and the labels provided by the fraud analyst 140 in subsequent training phases. This feedback loop aids in keeping the fraud detection models current with trends of fraudulent merchants 110.

The merchant fraud models can be used alone or in conjunction with other types of fraud models to detect fraudulent merchants 110. For example, other models focusing on other signals, such as the merchant's 110 account profile, transaction volume, and velocity, credit rating, or customer rating, may be used in conjunction the merchant fraud models described above. If one or more of the fraud models predict or classify the merchant 110 as fraudulent, a request can be issued to the fraud detection analyst 140 to review the merchant 110 further.

To improve the performance of the merchant fraud detection models, the fraud detection engine 132 can filter some merchants 110 from the prediction process. For example, merchants 110 having been reviewed a number of times and having had an account in good standing with the online payment processor 121 for a long period of time may be filtered from one or more prediction phases. If the fraud detection engine 132 executes the prediction phase on a periodic basis, such as once a day, these merchants 110 in good standing may be filtered from the daily executions but be included in a weekly execution. In another example, merchants 110 in good standing that would present small financial impact on the online payment processing service provider 120 if the merchants 110 were fraudulent may be filtered from some or all of the prediction phases.

The fraud detection engine 132 can also perform a performance evaluation on the merchant fraud detection models. In certain exemplary embodiments, the performance evaluation uses one-sided performance metrics, such as precision and recall for fraud prediction. The precision metric can be defined as the number of merchants 110 correctly predicted as fraudulent by the merchant fraud detection models divided by the total number of merchants 110 the merchant fraud detection models predicted as fraudulent. The recall metric can be defined as the number of merchants 110 correctly predicted as fraudulent divided by the number of all true fraudulent merchants 110. The fraud detection engine 132 can use feedback from the fraud analysts 140 to determine the number of merchants 110 correctly predicted by the merchant fraud detection models to be fraudulent and the number of all true fraudulent merchants 110. The fraud detection engine 132 can calculate the precision and recall for the merchant fraud detection models for one or more time periods and output the results for review by the fraud detection analyst 140 or another user. The fraud detection analyst 140 can then use the results to revise the merchant fraud detection models. For example, the fraud detection analyst 140 may tune the classifier parameters in the merchant fraud detection models to provide better precision or better recall. Additionally, the fraud detection analyst 140 may generate a new merchant fraud risk model based on a different algorithm or classifier model.

The fraud detection analyst 140 can also set and adjust a risk threshold that can be used by the fraud detection engine 132 to determine which merchants 110 are referred to the fraud analyst 140 for further review. For example, merchants 110 having a merchant risk score close to or exceeding the risk threshold may be referred to the fraud analyst 140. If the fraud analyst 140 desires to increase review coverage, the fraud analyst can set a lower risk threshold. Conversely, if the fraud analyst 140 desires to reduce the number of merchants 110 being referred, the fraud analyst 140 can increase the risk threshold.

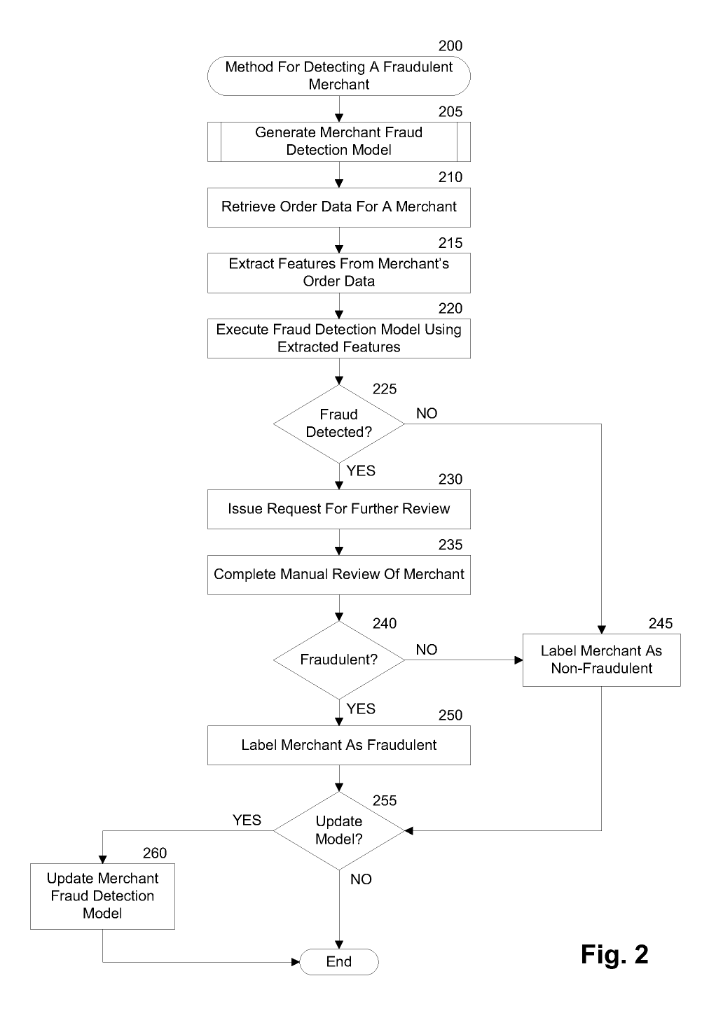

FIG. 2 is a flow chart depicting a method 200 for detecting fraudulent merchants in accordance with certain exemplary embodiments. The method 200 will be described with reference to FIGS. 1 and 2.

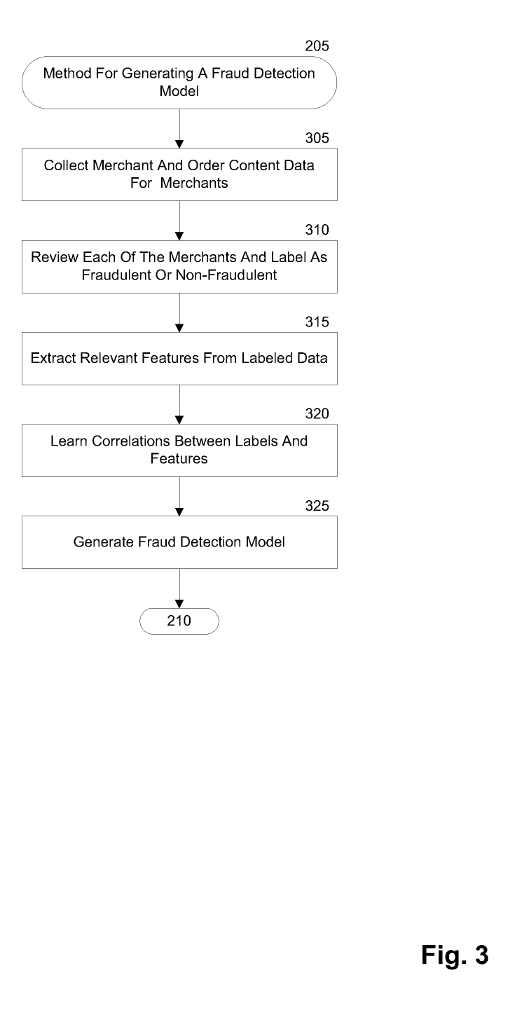

In step 205, one or more fraud detection models are generated. In one exemplary embodiment, the merchant and order content for multiple merchants 110 is collected and stored in the training database 123. The fraud analyst 140 reviews the merchant and order content data and labels each of the merchants 110 as fraudulent or non-fraudulent based on the review. The feature extractor 131 then extracts relevant feature data from the labeled order content data. The fraud detection engine 132 learns the correlations between the labels and features and generates one or more fraud detection models based on the correlations. Step 205 is described in further detail below with reference to FIG. 3.

In step 210, the fraud detection engine 132 retrieves unlabeled order content data for a merchant 110 that is the subject of the fraud detection. The fraud detection engine 132 can obtain this order content data from the order content database 122.

In step 215, the feature extractor 131 extracts relevant feature data from the merchant's 110 order content data. As described above with reference to FIG. 1, this feature data can include bag-of-word tokens from title and product descriptions from the merchant's 110 orders, bigrams over the bag-of-word tokens, and conjunctions of terms and binned prices. The extracted features can also include any other data from the order content data that the fraud detection engine 132 considers relevant to detecting fraud.

In step 220, the fraud detection engine 132 executes the one or more merchant fraud detection models using the extracted feature data for the merchant 110. The output of the fraud detection models can include a classification of fraudulent or non-fraudulent or can include a merchant risk score corresponding to the likelihood that the merchant 110 is fraudulent.

In step 225, if the merchant 110 is determined to be fraudulent by the fraud detection engine 132, the method 200 branches to step 230. Otherwise, the method 200 branches to step 245. In a merchant risk score embodiment, the fraud detection engine may compare the merchant risk score to a risk threshold to determine if the merchant 110 is fraudulent.

If the merchant 110 has a risk score that exceeds or is close to the risk threshold, or if the fraud detection engine 132 classified the merchant 110 as fraudulent in step 220, the fraud detection engine 132 issues a request for further review by the fraud analyst in step 230. In certain exemplary embodiments, the fraud detection engine 132 generates an e-mail message to the fraud analyst 140 to request a review. In certain exemplary embodiments, the fraud detection engine 132 adds the merchant 132 to a queue of merchants 110 flagged by the fraud detection engine 132 for further review by the fraud analyst 140. The merchants 110 may be prioritized in the queue based on merchant risk score, possible financial impact of the merchants 100 if they are fraudulent, and time since the previous review of the merchant 110.

In step 235, the fraud analyst 140 reviews the merchant 110 to determine if the merchant 110 is indeed fraudulent. The fraud analyst 140 can review the orders and transactions made by the merchant 110, information associated with payment methods (e.g., credit card information) used in the transactions, merchant 110 credit and financial status, photocopies of signed documents and signed delivery receipts, a verification of the merchant's 110 identity, and any other information that can be used to determine of the merchant 110 is fraudulent.

In step 240, if the fraud analyst 140 determines that the merchant 110 is fraudulent, the method 200 branches to step 250. Otherwise, the method 200 branches to step 245.

In step 245, the merchant 110 is labeled as non-fraudulent. This label can be based solely on the output of the merchant fraud detection model(s) or based on the review by the fraud analyst 140.

In step 250, the merchant 110 is labeled as fraudulent by the fraud analyst 140. Although in this exemplary embodiment, the fraud analyst 140 determines whether to label merchants 110 as fraudulent, in other embodiments, the merchant 110 may be labeled as fraudulent solely by the fraud detection engine 132.

In step 255, the method 200 determines whether to update the merchant fraud detection model(s). The fraud detection model(s) can be updated periodically or based on the needs of the online payment processing service provider 120. For example, the fraud detection model(s) may be updated once a week or once a month. Also, the fraud detection model(s) may be updated to more aggressively identify fraudulent merchants 110 based on a perceived risk to the online payment processing service provider 120. If the merchant fraud detection model(s) are to be updated, the method 200 branches to step 260. Otherwise the method 200 ends.

In step 260, the fraud detection engine 132 updates the merchant fraud detection model(s). In certain exemplary embodiments, the fraud detection engine 132 removes older training data and updates the training data with merchant and order content data labeled by the fraud detection engine 132 or the fraud analyst 140. In certain exemplary embodiments, the fraud analyst 140 can tune thresholds and classifiers within the merchant fraud detection model(s).

In an alternative embodiment, instead of the method 200 ending after steps 255 and/or 260, the method 200 can determine whether to continue monitoring the merchant 110 or another merchant 110 for fraud. If so, the method 200 can return to step 210 (or any other appropriate step) for the same or different merchant 110.

FIG. 3 is a flow chart depicting a method 205 for generating a fraud detection model, as referenced in step 205 of FIG. 2, in accordance with certain exemplary embodiments. The method 205 will be described with reference to FIGS. 1 and 3.

In step 305, training data including merchant data and order content data for each of the merchants 110 is collected and stored in the training database 123. This training data can include data associated with any number of merchants 110. For example, thousands of merchants 110 and order content data for millions of orders completed by the merchants 110 can be collected for the training data. This training data can come from merchants 110 having accounts or otherwise associated with the online payment processor 120. Alternatively or additionally, the training data can be obtained from external or third party sources.

In step 310, the fraud analyst 140 reviews each merchant and the order content data for each of the merchants 110 to determine whether each of the merchants 110 is fraudulent or non-fraudulent. The fraud analyst 140 then labels the merchant 110 and its associated data as fraudulent or non-fraudulent based on the review.

In step 315, the feature extractor 131 extracts relevant feature data from the labeled data and communicates the extracted feature data to the fraud detection engine 132. As described above with reference to FIG. 1, this feature data can include bag-of-word tokens from title and product descriptions from the merchant's 110 orders, bigrams over the bag-of-word tokens, and conjunctions of terms and binned prices. After extracting the feature data, the feature extractor 131 communicates the extracted feature data to the fraud detection engine 132.

In step 320, the fraud detection engine 132 learns the correlations between the features in the extracted feature data and the labels associated with the features. In step 325, the fraud detection engine 132 generates one or more merchant fraud detection models based on the correlations between the features and the labels. As described above, the merchant fraud detection models can be developed based on a probability based scoring algorithm, Naïve Bayes classifiers, Perceptron classifiers, Winnow classifiers, SVM classifiers, or any other statistical modeling. After step 325, the method 205 returns to step 210, as discussed above with reference to FIG. 2.

The exemplary methods and steps described in the embodiments presented previously are illustrative, and, in alternative embodiments, certain steps can be performed in a different order, in parallel with one another, omitted entirely, and/or combined between different exemplary methods, and/or certain additional steps can be performed, without departing from the scope and spirit of the invention. Accordingly, such alternative embodiments are included in the invention described herein.

The invention can be used with computer hardware and software that performs the methods and processing functions described above. As will be appreciated by those skilled in the art, the systems, methods, and procedures described herein can be embodied in a programmable computer, computer executable software, or digital circuitry. The software can be stored on computer readable media for execution by a processor, such as a central processing unit, via computer readable memory. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments of the invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by a person of ordinary skill in the art, having the benefit of this disclosure, without departing from the spirit and scope of the invention defined in the following claims, the scope of which is to be accorded the broadest interpretation so as to encompass such modifications and equivalent structures.

What is claimed is:

1. A computer program product for detecting a fraudulent merchant, the computer program product comprising:
a computer-readable medium comprising:
computer-executable program code for extracting feature data from a plurality of transactions completed by a merchant, the feature data comprising information associated with one or more products purchased in a transaction;
computer-executable program code for executing a fraud detection model using at least the extracted feature data to determine a risk score for the merchant based on the extracted feature data and a correlation of at least a portion of the extracted feature data with feature data associated with known fraudulent merchants; and
computer-executable program code for identifying the merchant for a further action based on the risk score for the merchant.

2. The computer program product of claim 1, wherein the further action comprises at least one of labeling the merchant as fraudulent, labeling the merchant as non-fraudulent, and issuing a request for the merchant to be reviewed further.

3. The computer program product of claim 1, further comprising computer-executable program code for comparing the risk score to a risk threshold to determine the further action.

4. The computer program product of claim 1, further comprising computer-executable program code for prioritizing a request for review of the merchant with a plurality of merchants based on the risk score of the merchant and risk scores for each of the plurality of merchants.

5. The computer program product of claim 2, further comprising:
computer-executable program code for labeling the merchant as fraudulent if the further review determines that the merchant is fraudulent; and
computer-executable program code for labeling the merchant as non-fraudulent if the further review determines that the merchant is non-fraudulent.

6. The computer program product of claim 5, further comprising computer-executable program code for updating the fraud detection model with the feature data associated with the merchant and the label associated with the merchant.

7. The computer program product of claim 1, wherein the fraud detection model determines a risk probability for each feature extracted and wherein the risk score comprises the sum of each of the risk probabilities.

8. The computer program product of claim 7, wherein the risk probability for each feature is directly proportional to the correlation of that feature with a feature associated with known fraudulent merchants.

9. The computer program product of claim 1, wherein fraud detection model comprises one of a Naïve Bayes, Perceptron, Winnow, and Support Vector Machine classifier model.

10. A computer program product for detecting a fraudulent merchant, the computer program product comprising:
a computer-readable medium comprising:
computer-executable program code for extracting feature data from a plurality of transactions completed by a merchant, the feature data comprising information associated with one or more products purchased in a transaction;
computer-executable program code for executing a fraud detection model using at least the extracted feature data to determine a risk score for the merchant based on the extracted feature data and a correlation of at least a portion of the extracted feature data with feature data associated with known fraudulent merchants;
computer-executable program code for determining whether the risk score for the merchant comprises a risk score indicative of a fraudulent merchant; and
computer-executable program code for classifying the merchant as fraudulent based on a determination that the risk score for the merchant comprises a risk score indicative of a fraudulent merchant.

11. The computer program product of claim 10, further comprising computer-executable program code for classifying the merchant as non-fraudulent based on a determination that the risk score for the merchant comprises a risk score indicative of a non-fraudulent merchant.

12. The computer program product of claim 10, wherein the computer-executable program code for determining whether the risk score for the merchant comprises a risk score indicative of a fraudulent merchant comprises computer-executable program code for comparing the risk score for the merchant to a risk threshold, wherein the merchant is classified as fraudulent if the risk score exceeds the risk threshold.

13. The computer program product of claim 10, further comprising computer-executable program code for issuing a request for the merchant to be review further is the merchant comprises a classification of fraudulent.

14. The computer program product of claim 13, further comprising computer-executable program code for prioritizing a request for further review of the merchant with a plurality of merchants classified as fraudulent based on the risk score of the merchant and risk scores for each of the plurality of merchants classified as fraudulent.

15. The computer program product of claim 14, further comprising:
computer-executable program code for associating the merchant with a fraudulent label if the review determines that the merchant is fraudulent; and
computer-executable program code for associating the merchant with a non-fraudulent label if the review determines that the merchant is non-fraudulent.

16. The computer program product of claim 15, further comprising computer-executable program code for updating the fraud detection model with the feature data associated with the merchant and the label associated with the merchant.

17. The computer program product of claim 10, wherein fraud detection model comprises one of a Naïve Bayes, Perceptron, Winnow, and Support Vector Machine classifier model.

18. A system for detecting fraudulent merchants, the system comprising:
an online payment processor for receiving transaction data associated with a plurality of transactions completed by each of a plurality of merchants, the transaction data comprising information associated with one or more products purchased in a transaction;
a feature extractor in communication with the online payment processor for extracting feature data from the transaction data; and
a fraud detection engine for:
receiving the extracted feature data from the feature extractor for each merchant;
executing a fraud detection model using at least the extracted feature data to determine a risk score for each merchant based on the extracted feature data for that merchant and a correlation of at least a portion of the extracted feature data for that merchant with feature data associated with known fraudulent merchants; and
identifying each merchant for a further action based on the risk score for the merchant.

19. The system of claim 18, wherein the further action comprises at least one of labeling the merchant as fraudulent, labeling the merchant as non-fraudulent, and issuing a request for the merchant to be review further.

20. The system of claim 19, wherein the fraud detection engine prioritizes the further review for each merchant identified for further review based on the risk score for the merchants.

21. The system of claim 18, wherein the fraud detection model determines a risk probability for each of the extracted features and wherein the risk score comprises the sum of each of the risk probabilities.

22. The system of claim 21, wherein the risk probability for each feature is directly proportional to the correlation of that feature with a feature associated with known fraudulent merchants.

23. The system of claim 18, wherein fraud detection model comprises one of a Naïve Bayes, Perceptron, Winnow, and Support Vector Machine classifier model.

24. The system of claim 18, wherein the fraud detection engine filters merchants in good standing with the online payment processor from the execution of the fraud detection model.

25. The system of claim 18, wherein the fraud detection engine executes one or more additional fraud models for detecting fraudulent merchants using one of merchant account information, transaction volume, transaction velocity, credit rating, and customer rating.
